(19) United States
(12) Patent Application Publication
(10) Pub. No.: US 2004/0247183 A1
(43) Pub. Date: Dec. 9, 2004

(54) Method for image analysis

(76) Inventor: Soren Molander, Kista (SE)

Correspondence Address: HARNESS, DICKEY & PIERCE, P.L.C., P.O. BOX 8910, RESTON, VA, 20195, US

(21) Appl. No.: 10/482,389

(22) PCT Filed: Jun. 24, 2002
(86) PCT No.: PCT/SE02/01234

(30) Foreign Application Priority Data
Jul. 2, 2001 (SE) 01023605

(51) Int. Cl. G06K 9/62; G06K 9/48; G06K 9/00

(52) U.S. Cl. 382/209; 382/199; 382/117; 382/103

(57) ABSTRACT

The present invention relates to a method for locating the eyes in an image of a person, for example useful in eye-tracking. The method comprises selecting a region of interest in the image, preferably including the face of the person, using information from said selection in the steps of: selecting a plurality of candidate areas (“blobs) in this region of interest, matching said candidate areas of an edge map of the image with at least one mask based on a geometric approximation of the iris, selecting the best matching pair of candidate areas, and evaluating the relative geometry of said selected candidate areas to determine if the pair of candidate areas is acceptable. The key principle of the invention is to use information from the face detection to improve the algorithm for finding the eyes.

### TECHNICAL FIELD

The present invention relates to an image analysis method for locating the eyes in an image of a face. More specifically, the invention relates to such a method for use in a system for eye tracking.

### TECHNICAL BACKGROUND

A conventional method for eye tracking is based on defining a number of templates, consisting of portions of the face of the user who's eyes are being tracked. These templates are then identified in real time in a stream of images of the face, thereby keeping track of the orientation of the head.

The step of defining these templates is normally performed manually, for example by letting the user point out the relevant areas in an image shown on the screen, using a mouse or the like. It is desired to automate this process, making it quicker and less troublesome for the user. In some applications, such as drowsy-driver detection in cars, where a screen and pointing device are not necessarily present, the need for an automatic process is even greater.

In a neighboring field of technology, techniques for face recognition include extraction of facial features with the help of linear filters. An example of such a system is described in U.S. Pat. No. 6,111,517. In such systems it is the face characteristics as a whole that are identified and compared with information in a database. The recognition of faces can be performed continuously, automatically, by finding the location of the face in the image and extracting a number of facial characteristics from this face image.

The algorithms used in the above technology are however inadequate when attempting to acquire more detailed information about different parts of the face, such as the position of the iris. Such information is important when identifying templates to be used in the process of eye tracking.

Further, the art of face recognition does not provide a robust method for finding a specific feature, such as the location of the iris, in all faces. Rather, it is intended to compare one face with another.

### SUMMARY OF THE INVENTION

An object with the present invention is to provide a method for identifying facial features (templates) for future use in e.g. a tracking procedure.

A further object of the invention is to perform the method in real time.

Yet another object of the invention is to enable quick and efficient location of the eyes in a face.

According to the invention, these and other objects are achieved with a method comprising selecting a region of interest in the image, preferably including the face of the person, using information from said selection in the steps of: selecting a plurality of candidate areas (“blobs”) in this region of interest, matching said candidate areas of an edge map of the image with at least one mask based on a geometric approximation of the iris, selecting the best matching pair of candidate areas, and evaluating the relative geometry of said selected candidate areas to determine if the pair of candidate areas is acceptable.

The process of locating the eyes is thus divided into two, first a detection of the face, and then a detection of the eyes. The key principle of the invention is to use information from the face detection to improve the algorithm for finding the eyes. This information can for example be related to the size of the face, implicitly giving an estimate of the size of the eyes.

The masks are thus primarily matched against an edge map of the image. It is however preferred to combine this matching with a matching against the original (possibly down-sampled) contents of the image, in order to more accurately locate the eyes. Further, the matching can be performed several times, to obtain a robust method.

The step of selecting said region of interest preferably comprises acquiring a second, consecutive image, separated in time, and performing a comparison between the first and second images to select an area of change in which the image content has changed more than a predetermined amount. This technique is known per se, and has shown to be useful in the inventive method.

The step of locating said candidate areas preferably comprises applying a GABOR-filter to said region of interest, said GABOR filter being adapted to the size of said region of interest. Compared to conventional technology, it is important to note how the inventive method takes advantage from the face detection to adapt the GABOR filter. This reduces the required computation time significantly. The GABOR-filter can also be adapted to a priori knowledge of the geometry of the eyes (their orientation, relative position, etc), and especially in combination with previously acquired information.

The shape of the mask is preferably essentially circular, to fit the shape of the iris.

### BRIEF DESCRIPTION OF THE DRAWINGS

These and other aspects of the invention will be apparent from the preferred embodiments more clearly described with reference to the appended drawings.

FIG. 1 is a flowchart showing the two stages of the eye detection process, and the flow of information between these stages.

FIG. 2 is a more detailed flowchart of the face detection process.

FIG. 3 is a more detailed flowchart of the eye detection process.

FIG. 4 is an image of a face.

FIG. 5 is a thresholded difference image.

FIG. 6 shows the outline of a region of interest.

FIG. 7 is an input image for the eye detection process.

FIG. 8 is a GABOR-filter response to the image in FIG. 6.

FIG. 9 shows selected areas from the input image in FIG. 6.

FIG. 10 is a gradient edge map of the input image in FIG. 6.

FIG. 11 illustrates the masking process.

### DETAILED DESCRIPTION OF THE CURRENTLY PREFERRED EMBODIMENT

The preferred embodiment of the invention is related to an implementation in a system for tracking of the eyes of a user. As a part of the initialization process of the system, a number of templates, i.e. well defined areas of the face such as corner of the eyes, corners of the mouth etc., are identified, and then tracked. In order to find these templates, the eyes are located in an image of the face using the method according to the invention, and the “feature” that is identified is thus the location of the iris.

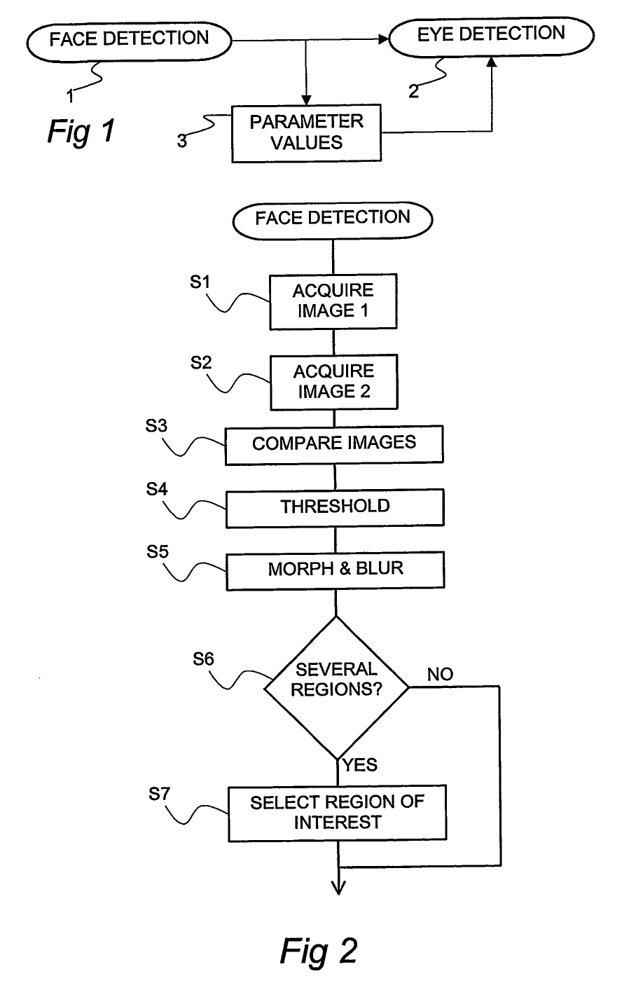

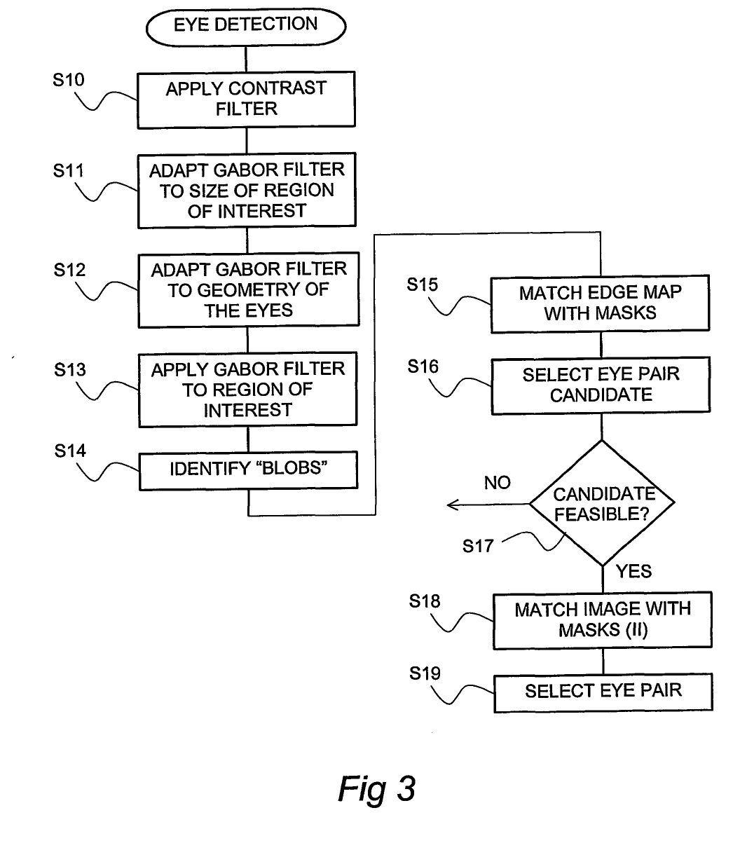

As show in FIG. 1, the eye detection process is performed in two stages, a face detection stage 1 and an eye detection stage 2. Information 3 from the face detection stage 1 is allowed to influence parametric values stored in a memory, and used in the eye detection stage 2 to achieve a robust and fast process. FIGS. 2 and 3 show the process in more detail.

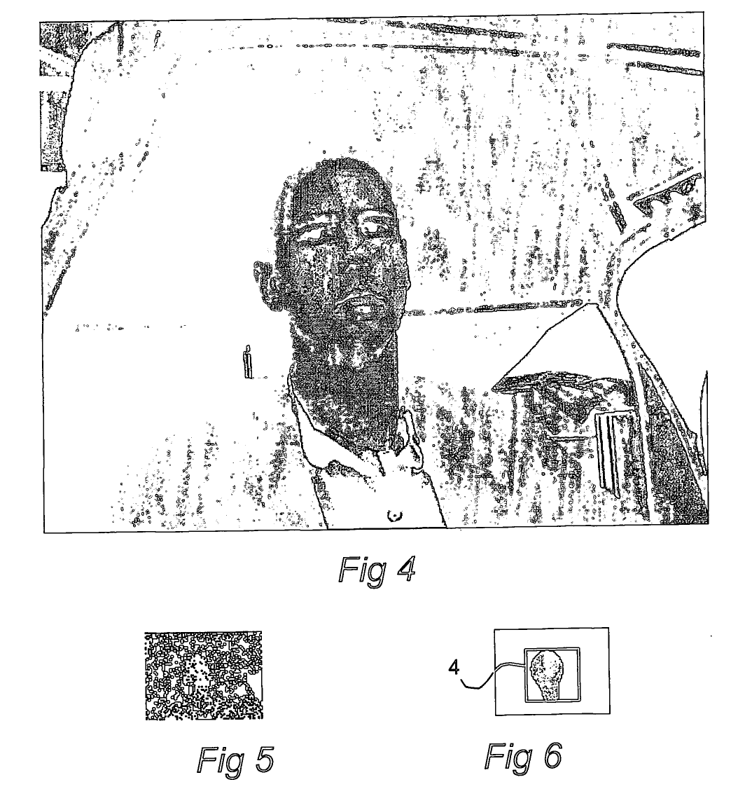

The face detection stage (FIG. 2)is performed using the difference between an original image, acquired in step S1, and a concurrent image, acquired in step S2 from the same source. FIG. 4 is an example of such an image, showing the driver of a car, and especially his face. The images are down sampled to include a suitable information content, where the sampling factor is dependent on the original size of the image. In the case of an original size of 640×494 pixels, the down sampling factor when establishing an image difference is 1/√2⁶=0.125. The exponent is normally designated level, and thus the difference between two concurrent images is established at level 6.

The two down sampled images are compared pixel by pixel in step S3, resulting in a third “difference” image, where the intensity in each pixel is proportional to the difference. This third image is then thresholded in step S4, i.e. each pixel is compared to a predefined value, and only pixels having a higher intensity are turned on. The result is illustrated in FIG. 5. In step S5, a morphological opening is applied to remove small speckles, and the image is finally blurred, in order to acquire one single region of interest, as shown in FIG. 6. In some cases the above process results in several regions, and the largest one is then chosen as the region of interest (step S7). The bounding box 4 of this region is used as an estimation of the size and position of the face.

The content of the bounding box 4 in the original image is used as input to the eye detection process shown in FIG. 3. It is first down sampled with a suitable factor, again assuming the above mentioned image size, the factor is 1/√2³=0.3535, i.e. level 3.

This input image, illustrated in FIG. 7, is contrast enhanced in step S10 by applying two different blurred Gaussian filters and taking the difference. A Gabor filter is then applied to this contrast enhanced image in step S13, leading to an image shown in FIG. 8. The black areas correspond to strong filter responses.

However, before the GABOR filter is applied in step S13, it is adapted with the help of information obtained in the face detection process (step S11), and a priori knowledge of the geometry of the eyes (step S12).

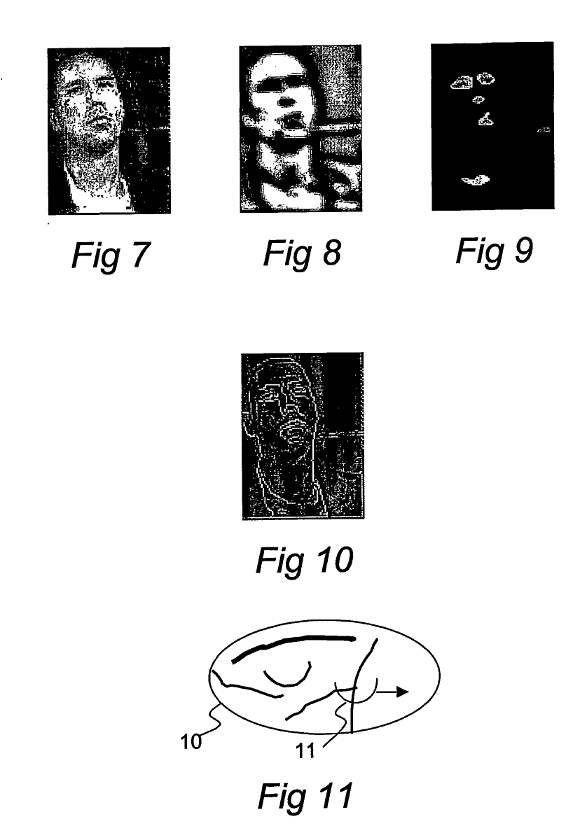

By thresholding the obtained GABOR filter response shown in FIG. 8, a number of candidate areas (blobs) are located in step S14. These blobs should include the eyes, but probably also some other areas with similar characteristics (e.g. the tip of the nose, mouth/chin, etc). These blobs define the coordinates of the input image in FIG. 7 where the desired feature is likely to be found. In FIG. 9 the corresponding areas from the image in FIG. 7 are illustrated.

A gradient edge map, illustrated in FIG. 10, is created by applying a combination of differentiated Gaussian filters in the x and y direction respectively. Non-maximal suppression is further used to obtain more distinct edges. In FIG. 10 the intensity of the lines indicate the sharpness of the edge.

Returning to FIG. 3, in step S15 the areas of the edge map corresponding to the blobs are then matched against a mask comprising an artificially created iris-edge, i.e. a circle with an estimated radius (based on the size of the bounding box, i.e. the estimated face-size). An elliptic shape is also possible, but requires more information due to the more complex shape. The masking is performed to obtain a measure of the edge content and contrast in each blob area.

FIG. 11 gives a schematic view of the masking process of a blob area 10 of an edge map. In this case the mask is only the lower half of a circle, which normally is sufficient at this stage. For each position of the mask 11, the intensity of pixels immediately inside the mask boundary are compared to the intensity of pixels immediately outside the mask boundary. When the difference exceeds a predefined threshold value, this indicates the presence of an edge in the blob area that is substantially aligned with the mask. At the same time, the intensity inside the mask is determined. A score is then allocated each blob, based on the amount of edge content and the variations in intensity. A large edge contact in combination with intensity variations lead to a high score. The exact weighting of these characteristics can be selected by the person skilled in the art.

The masking process S15 is performed for all blobs areas, five here. In order to achieve better redundancy, all blob areas are masked with three different masks, each having a different radius. Each blob gets a matching score for each mask size and for each mask a pair of the best scoring blobs is selected. If not at least two out of three pairs consist of the same blobs, this is an indication of that no eyes have been found with satisfactory certainty. In the ideal case, the blob pairs from each mask size are identical. The blob pair that achieved the highest score from at least two masks is considered to be a candidate for a pair of eyes (step S16).

Next, the blobs of the eye pair candidate are checked for the internal geometry, overlap scores, and other types of a priori knowledge in a filtering step S17. For example, candidates consisting of blobs too far apart in the x- or y-direction may be discarded. Again, information from the face detection is used. If the eye pair candidate is not acceptable, the process terminates and returns to the face detection stage 1.

If the eye pair candidate is acceptable, it is then further verified in a second masking process in step S18. This time, the mask is matched against the selected blob areas of the input image (FIG. 7), instead of the edge map. Instead of just comparing pixel intensity inside and outside the mask, this time the absolute values of these intensities are considered, and evaluated against expected, typical values. In other words, the masking process again leads to a measure of edge content, but only edges where the absolute intensity of each side is acceptable are included. This results in new a score for each mask size, where the highest value of the score is considered to correspond to a pair of eyes, thereby determining not only the position of the eyes, but also the size of the irises (the radius with the best score).

Most of the parameters related to the GABOR-filtering and mask matching are contained in a parameter file 3, shown in FIG. 1. Some are fixed through out the application, some are tuned after the face detection stage (FIG. 2), where the size of the region of interest is determined, and assumed to correspond to the size of the face. Values may also be adapted depending on the light conditions in the image.

It should be clear that the skilled man may implement the inventive method, defined in the claims, in different ways, modifying the herein described algorithm slightly. For example, the number of different radii could be different (e.g. only one), and the maskings can be performed in different order and in different combinations. It is also possible that only one masking is sufficient.

1. Method for locating the eyes in an image of a person, comprising
selecting a region of interest (4) in the image, preferably including the face of the person (S7),
using information from said selection in the steps of:
selecting a plurality of candidate areas (“blobs”) (S14) in the region of interest,
matching (S15) said candidate areas of an edge map of the image with at least one mask (11) based on a geometric approximation of the iris,
selecting (S16) the best matching pair of candidate areas, and
evaluating (S17) the relative geometry of said selected candidate areas to determine if the pair of candidate areas is acceptable.

2. Method according to claim 1, further comprising matching (S18) said pair of candidate areas of the image with said mask.

3. Method according to claim 1 or 2, wherein said matching (S15, S18) is performed several times, with masks with different sizes.

4. Method according to claim 1-3, wherein the step of selecting said region of interest comprises acquiring (S2) a second, consecutive image, separated in time, and performing a comparison (S3) between the first and second images to select an area of change in which the image content has changed more than a predetermined amount.

5. Method according to any one of the preceding claims, wherein the step of locating said candidate areas comprises applying (S13) a GABOR-filter to said region of interest, said GABOR filter being adapted (S11) to the size of said region of interest.

6. Method according to claim 4 or 5, wherein said GABOR-filter is adapted (S13) to a priori knowledge of the geometry of the eyes.

7. Method according to any of the preceding claims, wherein each mask (11) has essentially circular shape.
